(19) United States
(12) Patent Application Publication
(10) Pub. No.: US 2002/0082180 A1
(43) Pub. Date: Jun. 27, 2002

(54) Fabric cleaning system

(75) Inventors: Jan Kevelam, Vlaardingen (NL); Remco Johannes Koppert, Vlaardingen (NL); Irene Erica Smit, Vlaardingen (NL)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/025,134

(22) Filed: Dec. 19, 2001

(30) Foreign Application Priority Data
Dec. 20, 2000 (EP) 00204680.3

(51) Int. Cl. C11D 1/00

(52) U.S. Cl. 510/285; 510/505

(57) ABSTRACT

In a method of dry cleaning, textile fabrics are contacted with densified carbon dioxide composition. The composition further comprises a fluorescer, said fluorescer having either a log P of at least 2 or at least one Brönsted acidic or basic functional group with a pKa of more than 7.

### FIELD OF THE INVENTION

The present invention relates to a system for cleaning of textile fabrics, namely to a method of such cleaning and also compositions for carrying out that method. This system uses densified carbon dioxide as the main component of the cleaning liquor. As used herein, the term “densified carbon dioxide” includes both liquid carbon dioxide and supercritical carbon dioxide.

### BACKGROUND OF THE INVENTION

Conventionally, cleaning of textile fabrics such as clothes has been effected either by an aqueous wash process or by dry cleaning. The former method is performed either by hand or in a machine. A detergent composition is dissolved in water to create a wash liquor in which the fabrics are agitated. Then the fabrics are rinsed in clean water and dried. In a conventional dry cleaning process, the fabrics are first “pre-spotted” using a soap or detergent bar and a small amount of water to remove any visible stains. They are cleaned by agitation in a body of an organic solvent, which is then filtered and recycled for repeat use. The fabrics dry relatively easily in view of the volatile nature of the particular solvents which are normally used.

Conventional dry cleaning typically employs an organic solvent, especially, perchlorethylene (PERC) is widely used to clean fabrics. It is known to enhance PERC cleaning with surfactants and other additives. One desirable class of additives comprises fluorescers, sometimes also referred to as optical brighteners. Fluorescers are used to give an enhanced appearance of whiteness and/or cleanliness when the fabrics are viewed in natural daylight. However, they have sometimes been used for their sunscreen properties to protect colours from fading and/or protect the skin of the wearer from sunburn. They are capable of this subsidiary use because their fluorescent properties arise from the fact that they absorb ultra violet (UV) radiation and re-emit in the visible spectrum.

U.S. Pat. No. 3,640,881 describes how a fluorescer can be incorporated in a PERC dry cleaning bath, the ratio of PERC to the aqueous solution being high. However, the procedure is not efficient because the fluorescer has to be predissolved in water. In addition, a small amount of nonionic surfactant was also needed. A further drawback of this method is that the amount of fluorescer delivered is relatively low. An object of the present invention was to provide a dry cleaning composition which does not show one or more of these drawbacks.

We have now found that by virtue of the present invention, a specific selection of fluorescers can be more easily delivered to fabrics in a dry cleaning process provided that the dry cleaning composition comprises carbon dioxide and certain fluorescers.

Some additives have been described for carbon dioxide dry cleaning. For example, it is known to enhance stain resistance to fabrics by using a fluoroacrylate polymer in the process, as described in WO-A-98/54397. Other optional additives are also mentioned. It has also been proposed to enhance cleaning performance by including small amounts of water, particular surfactants and organic co-solvents, to form inverse micelles in the CO₂ medium. That is disclosed in WO-A-99/10585. For sizing or desizing yarns in the textile manufacturing industry, it has been proposed to bring the textile into contact with adhesives, binders, waxes, lubricants, antioxidants, stickiness inhibitors and mixtures thereof whilst “wetting” the textile with liquid CO₂.

Up to now, the carbon dioxide dry cleaning process has not proved to be capable of delivering fluorescers. The present invention solves this problem for the specific fluorescers described herein.

### DEFINITION OF THE INVENTION

Thus, a first aspect of the present invention provides a dry cleaning composition comprising densified carbon dioxide and a fluorescer, said fluorescer having either a log P of at least 2 or at least one Brönsted acidic or basic functional group with a pKa of more than 7.

The advantage of the inventive composition is that it less complex because no surfactant or water are needed to dissolve the inventive selection of fluorescers in carbon dioxide. This increases the flexibility of the dry cleaning composition. If optimal garment care is essential, the present invention may be used to formulate compositions without water and surfactant to dry clean garments using fluorescer. The inventive composition may also be used in separate step subsequent to a more conventional dry cleaning procedure possibly with surfactants and water. Alternatively, the inventive composition may still be used in the presence of small amounts of surfactants and water if cleaning is more important than care or in case the textile articles are not so sensitive to surfactants or water. A second aspect of the present invention provides a method of dry cleaning a textile fabric by contacting a fabric with a composition according to the first aspect of the invention.

In some cases it may be preferred to dry clean the textile in one step whereby a combination of cleaning agents are used. The fluorescers of the present invention are so flexible that they can be applied in the presence of other detersive or care ingredients such as enzymes, surfactants or even in the presence of other solvents. In these cases it may be preferable to make a premix of the fluorescer in a cosolvent and optional cleaning or care ingredients. Therefore, a third aspect of the present invention provides a method of preparing a dry cleaning composition according to the first aspect of the invention, said composition further comprising a cosolvent in which the fluorescer is soluble, the method comprising preparing a premix of the fluorescer, cosolvent, and optionally one or more of any other ingredients, admixing the premix with the densified carbon dioxide, and optionally any other remaining additional ingredients. Other suitable ingredients are usually detergent additives such as enzymes, perfumes, care ingredients like softeners etc. If the present invention is used seperate from a cleaning step, either before or after a cleaning step, then a preferred the dry cleaning composition comprises less than 0.1% , more preferably less than 0.01% by weight of the dry cleaning composition of surfactant.

### DETAILED DESCRIPTION

Recently, safety and environmental concerns have encouraged a search for an alternative dry cleaning method which does not use organic solvents. This has led to a system which utilises densified, eg liquid, carbon dioxide as the dry cleaning medium. At normal atmospheric pressure, as it is cooled, carbon dioxide passes from the gaseous to the solid state without ever becoming a liquid. Therefore, it is necessary to work in that part of the CO₂ phase diagram where it can exist in liquid or supercritical form. As a result, liquid CO₂ cleaning systems operate at an elevated pressure, typically about 50 times atmospheric pressure. The temperature is normally at or somewhat below ambient.

The method of fabric treatment with densified carbon dioxide comprises loading textile fabric, typically a variety of soiled articles, preferably clothing, into a vessel (preferably a pressurisable vessel) and contacting the articles with the composition according the invention. The composition minus the densified carbon dioxide may be contacted with the soiled articles before or together with the carbon dioxide. The carbon dioxide may be introduced into the cleaning vessel as described in U.S. Pat. No. 5,683,473. Preferably, the densified carbon dioxide is introduced into the cleaning vessel which is then pressurised to a pressure in the range of about 0.1 to about 68.9 MPa and adjusted to a temperature range of from about −78.5° C. up to about 30° C. so that the carbon dioxide is in a liquid phase. Preferably the pressure range is from 0.5 to 48 MPa, more preferably from 2.1 to 41 MPa. Preferably, the temperature range is from −56.2 to 25° C., more preferably from −25° C. to 20° C. After the cleaning step, the articles may be rinsed by introducing fresh carbon dioxide into the vessel after removing the dry cleaning composition. In one preferred embodiment, the carbon dioxide in the inventive composition is in liquid form.

Surfactants

The composition according the invention optionally also comprises a surfactant and water, although this is less preferred. Any surfactant suitable for use in such a composition known to the person skilled in the art may be used. Suitable surfactants are, for example, described in U.S. Pat. Nos. 5,789,505, 5,683,977, 5,683,473, 5,858,022 and WO 96/27704. Especially preferred are the surfactants described in WO 96/27704 (formulae I-IV) as hereinbelow.

Although an appropriate amount of surfactant (if present) is readily deducible for a given composition of the invention, using the techniques referred to above, typically the amount of total surfactant is from 0.001% to 10%, preferably from, 0.01% to 5% especially from 0.03% to 1% by weight of the total composition, including the densified carbon dioxide.

When a surfactant is present, it is preferred also to include some water. The amount of water (if present) is typically also from 0.001% to 10%, preferably from, 0.01% to 5% especially from 0.03% to 1% by weight of the total composition, including the densified carbon dioxide.

Further details of some preferred surfactants will now be given.

As used herein, the term “densified carbon dioxide-philic” in reference to surfactants RₙZₘ wherein n and m are each independently 1 to 50, means that the functional group, Rₙ— is soluble in carbon dioxide at pressures of from 101 kPa to 68.9 MPa and temperatures of from −78.5 to 100° C. to greater than 10 weight percent. Preferably n and m are each independently 1-35. Such functional groups (Rₙ—) include halocarbons, polysiloxanes and branched polyalkylene oxides.

The term “densified carbon dioxide-phobic” in reference to surfactants, RₙZₘ, means that Zₘ— will have a solubility in carbon dioxide of less than 10 weight percent at pressures of from 101 kPa to 68.9 MPa and temperatures of from −78.5 to 100° C. The functional groups in Zₘ— include carboxylic acids, phosphatyl esters, hydroxyls, C₁₋₃₀ alkyls or alkenyls, polyalkylene oxides, branched polyalkylene oxides, carboxylates, C₁₋₃₀ alkyl sulphonates, phosphates, glycerates, carbohydrates, nitrates, substituted or unsubstituted aryls and sulphates.

The hydrocarbon and halocarbon containing surfactants (i.e., RₙZₘ, containing the CO₂-philic functional group, Rₙ—, and the CO₂-phobic group, Zₘ—) may have an HLB of less than 15, preferably less than 13 and most preferably less than 12.

The polymeric siloxane containing surfactants, RₙZₘ, also designated MDₓD*_{y}M, with M representing trimethylsiloxyl end groups, Dₓ as a dimethylsiloxyl backbone (CO₂-philic functional group) and D*_{y} as one or more substituted methylsiloxyl groups substituted with CO₂-phobic R or R′ groups preferably have a DₓD*_{y} ratio of greater than 0.5:1, preferably greater than 0.7:1 and most preferably greater than 1:1.

A “substituted methylsiloxyl group” is a methylsiloxyl group substituted with a CO₂-phobic group R or R′. R or R′ are each represented in the following formula:

—(CH₂)ₐ(C₆H₄)_{b}(A)_{d}—[(L)ₑ(A′)_{f}]ₙ—(L′)_{g}Z(G)ₕ

wherein a is 1-30, b is 0-1, C₆H₄ is substituted or unsubstituted with a C₁₋₁₀ alkyl or alkenyl and A, d, L, e, A′, F, n L′, g, Z, G and h are defined below, and mixtures of R and R′.

A “substituted aryl” is an aryl substituted with a C₁₋₃₀ alkyl, alkenyl or hydroxyl, preferably a C₁₋₂₀ alkyl or alkenyl.

A “substituted carbohydrate” is a carbohydrate substituted with a C₁₋₁₀ alkyl or alkenyl, preferably a C₁₋₅ alkyl.

The terms “polyalkylene oxide”, “alkyl” and “alkenyl” each contain a carbon chain which may be either straight or branched unless otherwise stated.

A preferred surfactant which is effective for use in a composition according to the present invention requires the combination of densified carbon dioxide-philic functional groups with densified carbon dioxide-phobic functional groups (see definitions above). The resulting compound may form reversed micelles with the CO₂-philic functional groups extending into a continuous phase and the CO₂-phobic functional groups directed toward the centre of the micelle.

The CO₂-philic moieties of the surfactants are groups exhibiting low Hildebrand solubility parameters, as described in Grant, D. J. W. et al. “Solubility Behavior of Organic Compounds”, Techniques of Chemistry Series, J. Wiley & Sons, NY (1990) pp. 46-55 which describes the Hildebrand solubility equation, herein incorporated by reference. These CO₂-philic moieties also exhibit low polarisability and some electron donating capability allowing them to be solubilized easily in densified fluid carbon dioxide.

As defined above the CO₂-philic functional groups are soluble in densified carbon dioxide to greater than 10 weight percent, preferably greater than 15 weight percent, at pressures of from 101 kPa to 68.9 MPa and temperatures of from −78.5 to 100° C. Preferred densified CO₂-philic functional groups include halocarbons (such as fluoro-, chloro- and fluoro-chlorocarbons), polysiloxanes and branched polyalkylene oxides.

The CO₂-phobic portion of the surfactant molecule is obtained either by a hydrophilic or a hydrophobic functional group which is less than 10 weight percent soluble in densified CO₂, preferably less than 5 wt. %, at a pressures of from 101 kPa to 68.9 MPa and temperatures of from −78.5 to 100° C. Examples of moieties contained in the CO₂-phobic groups include polyalkylene oxides, carboxylates, branched acrylate esters, C₁₋₃₀ hydrocarbons, aryls which are unsubstituted or substituted, sulphonates, glycerates, phosphates, sulphates and carbohydrates. Especially preferred CO₂-phobic groups include C₂₋₂₀ straight chain or branched alkyls, polyalkylene oxides, glycerates, carboxylates, phosphates, sulphates and carbohydrates.

Preferred surfactants comprise CO₂-philic and CO₂-phobic groups. The CO₂-philic and CO₂-phobic groups are preferably directly connected or linked together via a linkage group. Such groups preferably include ester, keto, ether, amide, amine, thio, alkyl, alkenyl, fluoroalkyl, fluoroalkenyl and mixtures thereof.

A generalised definition of preferred surfactants is represented in the general formula:

RₙZₘ

wherein Rₙ— is a densified CO₂-philic functional group, R is a halocarbon, a polysiloxane, or a branched polyalkylene oxide and n is 1-50, and Zₘ— is a densified CO₂-phobic functional group, and

m is 1-50 and at pressures of 101 kPa to 68.9 MPa and temperatures of from −78.5 to 100° C., the Rₙ— group is soluble in the densified carbon dioxide to greater than 10 wt. percent and the Zₘ— group is soluble in the densified carbon dioxide to less than 10 wt. percent. It should be understood that Rₙ— and Zₘ— may be present in any sequence, e.g. RZR, ZRZ, RRRZ, RRRZRZ etc. etc.

Preferably, when R of the surfactant is the halocarbon or the branched polyalkylene oxide, then the surfactant has an HLB value of less than 15. In other cases it may be preferred that when R is the polysiloxane, then the surfactant has a ratio of dimethyl siloxyl to substituted methyl siloxy groups of greater than 0.5:1.

Surfactants which are useful in the invention may be selected from four groups of compounds (general formulae I-IV). The first group of compounds has the (I) formula:

[(CX₃(CX₂)ₐ(CH₂)_{b})_{c}(A)_{d}—[(L)ₑ—(A′)_{f}]ₙ—(L′)_{g}]ₒZ(G)ₕ (I)

wherein X is F, Cl, Br, I and mixtures thereof, preferably F and Cl;

a is 1-30, preferably 1-25, most preferably 5-20;

b is 0-5, preferably 0-3;

c is 1-5, preferably 1-3;

A and A′ are each independently a linking moiety representing an ester, a keto, an ether, a thio, an amido, an amino, a C₁₋₄ fluoroalkyl, a C₁₋₄ fluoroalkenyl, a branched or straight chain polyalkylene oxide, a phosphate, a sulphonyl, a sulphate, an ammonium and mixtures thereof;

d is 0 or 1;

L and L′ are each independently a C₁₋₃₀ straight chained or branched alkyl or alkenyl or an aryl which is unsubstituted or substituted and mixtures thereof;

e is 0-3;

f is 0 or 1;

n is 0-10, preferably 0-5, most preferably 0-3;

g is 0-3;

o is 0-5, preferably 0-3;

Z is a hydrogen, a carboxylic acid, a hydroxy, a phosphate, a phosphate ester, a sulphonyl, a sulphonate, a sulphate, a branched or straight-chained polyalkylene oxide, a nitryl, a glyceryl, an aryl unsubstituted or substituted with a C₁₋₃₀ alkyl or alkenyl, (preferably C₁₋₂₅ alkyl), a carbohydrate unsubstituted or substituted with a C₁₋₁₀ alkyl or alkenyl (preferably a C₁₋₅ alkyl) or an ammonium;

G is an anion or cation such as H⁺, Na⁺, Li⁺, K⁺, NH₄⁺ Ca⁺², Mg⁺²; Cl⁻, Br⁻, I⁻, mesylate, or tosylate; and h is 0-3, preferably 0-2.

Preferred compounds within the scope of the formula (I) include those having linking moieties A and A′ which are each independently an ester, an ether, a thio, a polyalkylene oxide, an amido, an ammonium and mixtures thereof;

L and L′ are each independently a C₁₋₂₅ straight chain or branched alkyl or unsubstituted aryl; and Z is a hydrogen, carboxylic acid, hydroxyl, a phosphate, a sulphonyl, a sulphate, an ammonium, a polyalkylene oxide, or a carbohydrate, preferably unsubstituted. G groups which are preferred include H⁺, Li⁺, Na⁺, NH⁺₄, Cl⁻, Br⁻ and tosylate.

Most preferred compounds within the scope of formula (I) include those compounds wherein A and A′ are each independently an ester, ether, an amido, a polyoxyalkylene oxide and mixtures thereof; L and L′ are each independently a C₁₋₂₀ straight chain or branched alkyl or an unsubstituted aryl; Z is a hydrogen, a phosphate, a sulphonyl, a carboxylic acid, a sulphate, a poly(alkylene oxide) and mixtures thereof; and G is H⁺, Na⁺ or NH₄⁺.

Compounds of formula (I) are prepared by any conventional preparation method known in the art such as the one described in March, J., “Advanced Organic Chemistry”, J. Wiley & Sons, NY (1985).

Commercially available fluorinated compounds include compounds supplied as the Zonyl™ series by Dupont.

The second group of surfactants useful in the inventive dry cleaning composition are those compounds having a polyalkylene moiety and having the general formula (II);

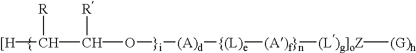

wherein R and R′ each represent a hydrogen, a C₁₋₅ straight chained or branched alkyl or alkylene oxide and mixtures thereof;

i is 1 to 50, preferably 1 to 30, and

A, A′, d, L, L′, e f, n, g, o, Z, G and h are as defined above.

Preferably R and R′ are each independently a hydrogen, a C₁₋₃ alkyl, or alkylene oxide and mixtures thereof.

Most preferably R and R′ are each independently a hydrogen, C₁₋₃ alkyl and mixtures thereof. Non-limiting examples of compounds within the scope of formula (II) are described in WO 96/27704.

Compounds of formula (II) may be prepared as is known in the art and as described in March et al., Supra.

Examples of commercially available compounds of formula (II) may be obtained as the Pluronic series from BASF, Inc.

A third group of surfactants useful in the invention contain a fluorinated oxide moiety and the compounds have the general formula (III):

[(CX₃(XO)ᵣ(T)ₛ)_{c}(A)_{d}—[(L)ₑ—(A′)_{f}—]ₙ(L′)_{g}]ₒZ(G)ₕ (III)

wherein XO is a halogenated alkylene oxide having C₁₋₆ straight or branched halocarbons, preferably C₁₋₃,

r is 1-50, preferably 1-25, most preferably 5-20,

T is a straight chained or branched haloalkyl or haloaryl,

s is 0 to 5, preferably 0-3,

X, A, A′, c, d, L, L′, e, f, n, g, o, Z, G and h are as defined above.

Examples of commercially available compounds within the scope of formula (III) include those compounds supplied under the Krytox™ series by DuPont having a formula:

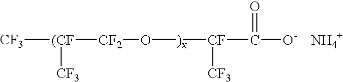

wherein x is 1-50.

Other compounds within the scope of formula III are made as known in the art and described in March et al., Supra.

The fourth group of surfactants useful in the invention include siloxanes containing surfactants of general formula (IV):

MDₓD*_{y}M (IV)

wherein M is a trimethylsiloxyl end group, Dₓ is a dimethylsiloxyl backbone which is CO₂-philic and D*_{y} is one or more methylsiloxyl groups which are substituted with a CO₂-phobic R or R′ group,

wherein R and R′ each independently have the following formula:

(CH₂)ₐ(C₆H₄)_{b}(A)_{d}—[(L)ₑ—(A′)_{f}—]ₙ—(L′)_{g}Z(G)ₕ

wherein a is 1-30, preferably 1-25, most preferably 1-20,

b is 0 or 1,

C₆H₄ is unsubstituted or substituted with a C₁₋₁₀ alkyl or alkenyl, and

A, A′, d, L, e, f, n, L′, g, Z, G and h are as defined above and mixtures of R and R′ thereof.

The Dₓ:D*_{y} ratio of the siloxane containing surfactants should be greater than 0.5:1, preferably greater than 0.7:1 and most preferably greater than 1:1.

The siloxane compounds should have a molecular weight ranging from 100 to 100,000, preferably 200 to 50,000, most preferably 500 to 35,000.

Silicones may be prepared by any conventional method such as the method described in Hardman, B. “Silicones” the Encyclopedia of Polymer Science and Engineering, v. 15, 2nd Ed., J. Wiley and Sons, NY, N.Y. (1989).

Examples of commercially available siloxane containing compounds which may be used in the invention are those supplied under the ABIL series by Goldschmidt.

Suitable siloxane compounds within the scope of formula (IV) are compounds of formula (V):

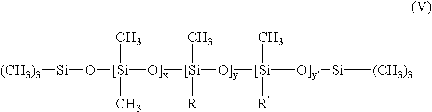

the ratio of x:y and y′ is greater than 0.5:1, preferably greater than 0.7:1 and most preferably greater than 1:1, and

R and R′ are as defined above.

Preferred CO₂-phobic groups represented by R and R′ include those moieties of the following formula:

(CH₂)ₐ(C₆H₄)_{b}(A)_{d}—[(L)ₑ(A′)_{f}—]—(L′)_{g}Z(G)ₕ

wherein a is 1-20,

b is 0,

C₆H₄ is unsubstituted,

A, A′, d, L, e, f, n, g, Z, G and h are as defined above, and mixtures of R and R′.

Particularly useful surfactants are selected from the group consisting of the classes of ethoxy modified polydimethylsiloxanes (e.g. Silwet™ surfactants from Witco), acetylenic glycol surfactants (from Air Products) and ethoxy/propoxy block copolymers (e.g. Pluronic™ surfactants from BASF) and mixtures thereof.

Fluorescers

We have found the fluorescers of the present invention to be very effective when used with carbon dioxide whilst the fluorescers are readily soluble in carbon dioxide without the need for surfactants. A preferable selection of fluorescers can be described by their log P value. Log P being the partitioning coefficient of the fluorescer between octanol and water at ambient temperature, whereby P is the concentration of the fluorescer in octanol divided by the concentration of fluorescer in water. (Leo et al. Chem Rev 1971, 71, 525). If appropriate, the log P is determined in the presence of sodium and/or chloride as counterions. Accordingly, a preferred group of fluorescer has a log P of at least 2, more preferably at least 2.5. In many cases, the log P may also be estimated using specially designed programs, also described as clog P or calculated log P. However, if in certain cases these programs are inappropriate, the real log P should be measured.

Another preferable group of fluorescers can be described by the presence and pKa of certain functional groups in the fluorescer. Therefore, a preferred group of hydrophilic fluorescers comprises fluorescers having at least one or more Brönsted acidic, basic functional groups or mixtures thereof with a pKa of more than 7. A Brönsted acidic functional group is generally defined as a —AH group having a pKa of 7 or less for the equilibrium dissociation constant Ka=[—A—] [H⁺]/[—AH]. Likewise a Brönsted basic functional group is generally defined as a —B group, the conjugate acid of it (i.e. BH⁺) having a pKa of 7 or less for the equilibrium dissociation constant Ka=[—B] [H⁺]/[—BH⁺]. Examples of acidic functional groups include sulphonate, carboxylate, sulphate, phospate, phosphonate and phosphinate. Examples of basic functional groups include amino groups, primary, secondary and tertiary amine groups.

Some preferred classes of fluorescers according the invention are coumarins, eg Tinopal™ SWN and bis-benzoxazoles, eg. Tinopal™ SOP.

Overall, the total amount of fluorescer material in the composition is preferably from 0.1 to 1000 ppm, preferably from 1 to 500 ppm, eg from 5 to 150 ppm.

Modifiers

The dry cleaning composition may also be designed to include a modifier, such as water, or an organic solvent up to only about 10 wt %, and usual detergent additives to boost cleaning performance such as enzymes, surfactants, perfumes, whiteners and antistats each up to about 10 wt %.

In a preferred embodiment, a modifier such as water, or a useful organic solvent may be added with the stained cloth in the cleaning drum in a small volume. Preferred amounts of modifier should be from 0.0 to about 10 wt % (weight/weight of the CO₂), more preferably 0.001 to about 5 wt %, even more preferably 0.01 to about 3 wt %, most preferably from about 0.05 to about 0.2 wt %. Preferred solvents include water, ethanol, acetone, hexane, methanol, glycols, acetonitrile, C₁₋₁₀ alcohols and C₅₋₁₅ hydrocarbons and mixtures thereof. Especially preferred solvents include water, ethanol and methanol. If the modifier is water, optionally 0.1 to 50% of an additional organic cosolvent may be present as described in U.S. Pat. No. 5,858,022. In those circumstances it may be preferred to use surfactants as described in U.S. Pat. No. 5,858,022 which do contain a CO₂ philic group.

Cosolvent

Optionally, the composition further comprises a cosolvent in which the hydrophobic fluorescer is soluble, e.g. at from 0.001% to 30%, preferably from 0.01.% to 10% by weight of the cosolvent, relative to the weight of the total composition. Preferably, the cosolvent is incorporated at a weight ratio of from 100:1 to 1,000:1 of cosolvent to fluorescer. Suitable classes of cosolvent are alkanes, especially C₁₋₆alkanes, alcohols, especially C₁₋₆alcohols, alcohols with aromatic groups and their corresponding esters, e.g. carboxylic acid esters, ethers, especially C₁₋₆ ethers, as well as aldehydes and ketones, both also preferably having 1-6 carbon atoms, and mixtures of any two or more of the foregoing. Especially suitable are for example ethanol and phenoxypropanol

Other than in the examples, or where otherwise indicated, all numbers expressing quantities of ingredients or reaction conditions used herein are to be understood as modified in all instances by the term “about”. Similarly, all percentages are weight/weight percentages of the carbon dioxide unless otherwise indicated. Molar ranges are weight per volume of carbon dioxide. Where the term comprising is used in the specification or claims, it is not intended to exclude any terms, steps or features not specifically recited.

### EXAMPLES

The present invention will now be explained in more detail by way of the following non-limiting examples.

### Example 1

Solid granules of Tinopal™ SOP (log P>2.5) was put on the bottom of a 600 ml autoclave having a gas compressor, an extraction composition and a stirrer. Four white fluorescer-free cotton swatches (ca. 3×7 cm) were put on the stirrer, the bottom of which acts as a plateau (the plateau prevents direct contact of the swatches with the fluorescer). The cloths were allowed to move freely in the autoclave. Good agitation was ensured by visual observation with an endoscope through a small sapphire window in the autoclave. After placing the cloths in the autoclave and sealing it, liquid CO₂ at a tank pressure of 5.86 Mpa was allowed into the composition and was cooled to reach a temperature of about 12° C. at which point the liquid CO₂ was at a pressure of about 5.52 MPa. The stirrer was then turned on for 15 minutes to mimic a wash cycle. Optionally, at the completion of the wash cycle fresh CO₂ may be passed through the composition to mimic a rinse cycle. The pressure of the autoclave was then released to atmospheric pressure and the cleaned cloths were removed from the autoclave.

The resulting concentration of fluorescer which completely dissolved in the solvent was 130 ppm.

The contents of the autoclave were stirred at 200 rpm for 15 minutes. The swatches were removed from the autoclave and allowed to dry. Reflection spectra were recorded using an X-rite spectrophotometer model 968 (with the UV filter removed from the instrument). The efficacy of fluorescer delivery was assessed by comparing the reflectivity at 440 nm, expressed as ΔR (440) defined as R (440) after treatment minus R (440) of untreated swatch. Averaged readings from the four swatches were taken. A significant improvement in reflectivity was obtained.

### Example 2

The experiment of Example 1 was repeated using 13 ppm Tinopal™ SWN in place of Tinopal™ SOP and good results were obtained.

### Example 3

The experiment of Example 1 was repeated whereby Tinopal™ SOP was first predissolved in ethanol (2 g/Kg) and 6 gram of this solution was added into the stirred autoclave. Similar results were obtained compared to Example 1. The endconcentration fluorescer was 21 ppm.

### Example C1

The experiment of Example 1 was repeated whereby Tinopal™ SOP was replaced by solid granules of Tinopal™ UNPA-GX. Tinopal™ UNPA-GX is not a fluorescer according the present invention having a log P of less than 2 and Tinopal™ UNPA-GX performed unsatisfactory. The cloths were spotted and there was no improvement in reflectivity.

1. A dry cleaning composition comprising densified carbon dioxide and a fluorescer, said fluorescer having either a log P of at least 2 or at least one Brönsted acidic or basic functional group with a pKa of more than 7.

2. A dry cleaning composition according to claim 1, wherein the hydrophobic fluorescer is selected from coumarin fluorescers and bis-benzoxazole fluorescers.

3. A dry cleaning composition according to claim 1, wherein said composition comprises from 0.1 to 1000 ppm of fluorescer by weight of the composition.

4. A composition according to claim 1, wherein said composition further comprises a cosolvent in which the fluorescer is soluble.

5. A composition according to claim 4, wherein the cosolvent is selected from. alkanes, and their corresponding esters, aldehydes and ketones and mixtures of any two or more of the foregoing.

6. A composition according to claim 4, wherein said composition comprises from 0.001 to 30 wt. % cosolvent.

7. A dry cleaning composition according to claim 1 wherein the composition further comprises a surfactant, wherein the surfactant is selected from compounds of general formula
RₙZₘ
wherein Rₙ— is a densified CO₂-philic functional group, R is a halocarbon, a polysiloxane, or a branched polyalkylene oxide and n is 1-50, and Zₘ— is a densified CO₂-phobic functional group, and
m is 1-50 and at pressures of 101 kPa to 68.9 MPa and temperatures of from −78.5 to 100° C., the Rₙ— group is soluble in the densified carbon dioxide to greater than 10 wt. percent and the Zₘ— group is soluble in the densified carbon dioxide to less than 10 wt. percent.

8. A dry cleaning composition according to claim 1 wherein the dry cleaning composition comprises less than 0.1% of surfactant by weight of the dry cleaning composition.

9. A method of preparing a dry cleaning composition according to claim 4, wherein the method comprises preparing a premix of the fluorescer, cosolvent, and optionally one or more of any other ingredients, admixing the premix with the densified carbon dioxide, and optionally any other remaining additional ingredients.

10. A method of dry cleaning a textile fabric, wherein the method comprises contacting the fabric with a composition according to claim 1.

11. A method according to claim 10, wherein the densified carbon dioxide is evaporated after the cleaning process.
